(19) United States
(12) Patent Application Publication
(10) Pub. No.: US 2025/0033063 A1
(43) Pub. Date: Jan. 30, 2025

(54) GRINDING ADAPTER FOR A DUAL ASYMMETRIC CENTRIFUGAL MIXER AND METHOD OF USE THEREOF

(71) Applicant: 11559010 CANADA INC., Hamilton (CA)

(72) Inventor: Christopher Walter NICKELS, Toronto (CA)

(21) Appl. No.: 18/913,622

(22) Filed: Oct. 11, 2024

Related U.S. Application Data
(63) Continuation-in-part of application No. 18/848,418, filed on Jan. 1, 0001.
(60) Provisional application No. 63/327,575, filed on Apr. 5, 2022.

(51) Int. Cl. B02C 17/18; B01F 29/15; B01F 33/80; B01F 35/00; B02C 17/02

(52) U.S. Cl. CPC B02C 17/18; B01F 29/15; B01F 33/83613; B01F 35/188; B02C 17/02

(57) ABSTRACT

An adapter for enabling grinding of one or more materials using a centrifugal mixer, the adapter to be fitted into a container of the centrifugal mixer; it has a body defining an inner compartment, the body including openings; a filter positioned or for positioning around the body; and wherein the inner compartment is configured to receive grinding media for grinding the one or more materials and the openings are adapted to enable the one or more materials to enter and/or leave the inner compartment for grinding by the grinding media when subject to the centrifugal force applied by the centrifugal mixer while maintaining the grinding media in the inner compartment, the filter is adapted to filter the one or more materials that are ground to a size suitable to pass through the filter; a method of use thereof.

The present application is a continuation-in-part application of U.S. patent application Ser. No. 18/848,418, incorporated herein by reference, which is a national phase entry of International PCT Patent Application No. PCT/CA2023/050464, filed on Apr. 5, 2023, that claims priority from U.S. Provisional Patent Application No. 63/327,575, filed on Apr. 5, 2022, incorporated herein by reference.

### TECHNICAL FIELD

The present disclosure relates to centrifugal mixers, and more particularly to adapters for enabling grinding using centrifugal mixers.

### BACKGROUND

Dual asymmetric centrifugal mixers have traditionally been used for mixing materials in any physical form, such as, powders, pastes, creams, liquids, gels, such that the sample following mixing is homogeneous. An exemplary dual asymmetric centrifugal mixer is the FlackTek SPEEDMIXER™. However, these mixers have not previously possessed the capacity to reliably and consistently perform comminution such that they can be competitive with other grinding technologies. As such, laboratories and other users requiring both mixing and grinding capabilities have been required to invest in multiple pieces of equipment, that of a machine capable of comminution, such as a shaker, planetary, or other mill, and a machine capable of mixing, such as the FlackTek SPEEDMIXER™. This has been costly and inconvenient for the user, as the user has to purchase multiple pieces of equipment.

As such, there would be an advantage in providing a solution to enable both mixing and grinding in a dual asymmetric centrifugal mixer, or simply to use a dual asymmetric centrifugal mixer for grinding.

### SUMMARY

The present disclosure relates to solutions for adapting a dual asymmetric centrifugal mixer, traditionally used for mixing materials, to perform efficient, reliable, and reproducible comminution of solid materials.

The present disclosure relates to a grinding adapter for use with a dual asymmetric centrifugal mixer. The adapter includes an inner compartment for containing or that contains grinding media.

The adapter is for insertion into the container of the dual asymmetric centrifugal mixer, the container that is also designed for receiving the materials to be mixed with the dual asymmetric centrifugal mixer without the adapter.

The one or more materials to be ground are then added to the container (can be contained in the adapter that is inserted into the dual asymmetric centrifugal mixer). Centrifugal force is then applied by the dual asymmetric centrifugal mixer to the container. The centrifugal force results in comminution between the one or more materials and the grinding media, thereby resulting in the grinding of the one or more materials.

The adapter includes openings for enabling the one or more materials, (e.g. in some instances, when sufficiently ground), to flow between the inner compartment of the adapter and the container of the dual asymmetric centrifugal mixer. In some embodiments, the ground one or more materials are filtered as a function of size, based on the dimensions of the openings of the adapter. In other embodiments, the one or more materials may pass freely through the openings of the adapter during grinding, circulating in and out of the adapter containing the grinding media, throughout the time of the grinding process. As such, the openings are large enough to allow the one or more materials to be ground to move in and out of the adapter while preventing the grinding media from leaving the adapter. The one or more materials may flow in and out of the inner compartment through the openings, when subject to the centrifugal force applied by the dual asymmetric centrifugal mixer. The openings are sufficiently small to keep the grinding media in the grinding adapter.

The adapter can be removed from the container, the ground one or more materials recovered from the container.

A broad aspect is an adapter for enabling grinding of one or more materials using a dual-asymmetric centrifugal mixer, the adapter to be fitted into a container of the dual-asymmetric centrifugal mixer. The adapter includes a shell defining an inner compartment; and openings in the shell, wherein the inner compartment is configured to receive the grinding media for grinding the one or more materials and the openings enable the one or more materials to enter and/or leave the inner compartment for grinding by the grinding media when subject to the centrifugal force applied by the centrifugal mixer while maintaining the grinding media in the inner compartment.

In some embodiments, the shell may be shaped as a sphere.

In some instances, the shell may be shaped as a doughnut.

In some embodiments, the shell may be shaped as a right cylinder (i.e. a cylinder with an axial hole).

In some instances, the shell may be shaped as a cylinder.

In some embodiments, the shell may include a top surface; a base surface opposite the top surface; and a wall interconnecting the top surface and the base surface at the perimeter of the base surface and the perimeter of the top surface.

In some embodiments, the wall may be shaped as a cylinder, and each of the top surface and the base surface is shaped as a disc.

In some embodiments, the adapter may include a support for creating space under the base surface.

In some embodiments, the support may connect to a top of a container of the centrifugal mixer.

In some embodiments, the support may sit on a base of a container of the centrifugal mixer.

In some embodiments, the support may include a plurality of feet.

In some embodiments, the support may include a ring positioned along the perimeter of the base surface.

In some embodiments, the adapter may include one or more spacers positioned on an outside surface of the shell for preventing contact between the container of the centrifugal mixer and the shell.

In some embodiments, the one or more spacers may be a ring.

In some embodiments, the ring may be located at or near a top of the adapter.

In some embodiments, the ring may include an elastomeric loop around an outside edge of the ring for reducing damage to the container of the centrifugal mixer when the adapter is positioned in the container.

In some embodiments, the one or more spacers may include a plurality of nipples interspersed along the outside surface of the wall.

In some embodiments, the one or more spacers may include a plurality of fins interspersed along the outside surface of the wall.

In some embodiments, the feet may be the one or more spacers.

In some embodiments, the one or more spacers may include a plurality of fins interspersed along the outside surface of the wall.

In some embodiments, the openings may form a pattern of holes.

In some embodiments, the openings may be slits.

In some embodiments, the shell may be a cage defining the openings.

In some embodiments, the adapter may include a lid, and a body including the base surface and the wall, wherein the top surface is defined by the lid, and the lid is removable from the body to access the inner compartment for adding or removing the grinding media from the inner compartment.

In some embodiments, the lid may be joined to the body, sealing the inner compartment, by screwing onto threads of the body.

In some embodiments, the adapter may include the grinding media.

Another broad aspect is a kit for adapting a centrifugal mixer for grinding one or more materials. The kit includes the adapter as defined herein for fitting into the container of the centrifugal mixer; and a strainer support for mounting onto a rim of the container, the strainer support comprising arms oriented to extend into the container when the strainer support is mounted onto the rim of the container, for joining to the adapter and for suspending the adapter at a height from a base of the container, whereby one or more residual ground materials present on the adapter leave the adapter when a centrifugal force is applied by the centrifugal mixer to the suspended adapter.

In some embodiments, the strainer support may include an outer ledge, and wherein the strainer support may be configured to mount onto the rim of the container when the outer ledge rests on the rim of the container.

In some embodiments, the adapter may include protrusions or openings, wherein the arms of the strainer support may include hooks for joining to the protrusions or openings of the adapter.

In some embodiments, the adapter may include a spacer positioned on an outside surface of the shell for preventing contact between the container of the centrifugal mixer and the shell, and wherein the protrusions or the openings may be located on or as part of the spacer, the spacer shaped as a ring.

In some embodiments, the adapter may include the openings and the protrusions, the openings created by the protrusions, the protrusions acting as spokes interconnecting the ring to the shell of the adapter, and wherein the hooks of the strainer support may pass through the openings to join to the protrusions of the adapter, wherein the outer ledge of the support may include cavities for receiving the protrusions of the adapter, and wherein the protrusions of the adapter fit into the cavities of the outer ledge following a rotation of the adapter or the strainer support, interlocking the adapter and the strainer support.

In some embodiments, the adapter may includes the openings and the protrusions, the openings created by the protrusions, the protrusions acting as spokes interconnecting the ring to the shell of the adapter, and wherein the hooks of the strainer support may pass through the openings to join to the protrusions of the adapter, wherein the arms of the strainer support ends with hooks defining cavities for receiving the protrusions of the adapter, and wherein the protrusions of the adapter may fit into the cavities of the hooks following a rotation of the adapter or the strainer support, interlocking the adapter and the strainer support.

Another broad aspect is a method for adapting a dual-asymmetric centrifugal mixer for grinding one or more materials, comprising placing an adapter into a container of the dual-asymmetric centrifugal mixer, the adapter including an inner compartment for receiving grinding media for grinding the one or more materials, openings for allowing the one or more materials to enter and/or leave the inner compartment, enabling the one or more materials to flow between the inner compartment of the adapter and a space of the container not occupied by the adapter.

In some embodiments, the method may include inserting the grinding media into the inner compartment.

In some embodiments, the grinding media may be inserted into the inner compartment by unscrewing a lid of the adapter that is joinable to a body of the adapter, the lid and the body defining an inner compartment.

Another broad aspect is a method of grinding one or more materials using a dual-asymmetric centrifugal mixer. The method includes placing an adapter containing, in an inner compartment of the adapter, grinding media into a container of the centrifugal mixer; adding the one or more materials to the container; and applying a centrifugal force to the container containing the one or more materials, the centrifugal force causing the one or more materials to flow between the inner compartment and the container, the one or more materials colliding with the grinding media, resulting in the grinding of the one or more materials.

In some embodiments, the method may include adding the grinding media to the inner compartment by accessing the inner compartment by detaching a lid of the adapter from a body of the adapter, the inner compartment defined by the lid and the body.

In some embodiments, the lid may be detached from the body by unscrewing the lid from the body.

In some embodiments, the method may include, once the one or more materials are ground, suspending the adapter above a base of the container, from a rim of the container, and reapplying a centrifugal force to the suspended container, for removing residual ground one or more materials from the adapter, collected in the container.

In some embodiments, the adapter may be suspended by hooking the adapter to a strainer support including an outer ledge that rests on the rim of the container.

Another broad aspect is a dual-asymmetric centrifugal mixer that has been adapted for grinding comprising the adapter as defined herein for insertion into a container of the dual-asymmetric centrifugal mixer that is adapted for being subject to a centrifugal force applied by the dual-asymmetric centrifugal mixer.

Another broad aspect is a dual-asymmetric centrifugal mixer that has been adapted for grinding comprising the kit as defined herein, wherein the adapter is for insertion into a container of the dual-asymmetric centrifugal mixer that is adapted for being subject to a centrifugal force applied by the dual-asymmetric centrifugal mixer, and wherein the strainer support is configured to be mounted onto the rim of the container.

Another broad aspect is an adapter for enabling grinding of one or more materials using a dual-asymmetric centrifugal mixer, the adapter to be fitted into a container of the dual-asymmetric centrifugal mixer. The adapter includes a shell defining an inner compartment; openings in the shell; and a support configured to enable the adapter to rest onto a rim of the container, wherein the inner compartment is configured to receive the grinding media for grinding the one or more materials and the openings enable the one or more materials to enter and/or leave the inner compartment for grinding by the grinding media when subject to the centrifugal force applied by the centrifugal mixer while maintaining the grinding media in the inner compartment.

In some embodiments, the support may include a series of arms interspersed around an outside of the shell, the arms extending away from the adapter and configured to mount onto the rim of the container.

In some embodiments, the support may include a ledge around the shell and extending outwardly from the shell, the ledge configured to rest onto the rim of the container.

Another broad aspect is a strainer support adapted to support a grinding adapter while subject to a centrifugal force. The strainer support includes a main body; and arms oriented to extend from the main body and away from the main body into a container of a dual asymmetric centrifugal mixer, wherein an end of each of the arms comprises a hook for supporting a grinding adapter and for suspending the grinding adapter at a height from a base of the container.

In some embodiments, the main body may be a ring adapted to sit on a rim of the container.

In some embodiments, the main body may be the container.

Another broad aspect is a method of cleaning a grinding adapter located in a container of a dual asymmetric centrifugal mixer by applying a centrifugal force by a dual asymmetric centrifugal mixer. The method includes gripping onto or through one or more openings of a shell of the grinding adapter to connect the grinding adapter onto ends of the arms of a strainer support extending into an inner space of the container; and applying a centrifugal force to the grinding adapter suspended from the strainer support to remove residual materials from the grinding adapter.

In some embodiments, the openings may be slots.

In some embodiments, a body of the strainer support may be the container, and wherein the arms may extend from the container into the inner space of the container.

In some embodiments, the strainer support may include a ring for mounting onto a rim of the container, the arms extending from the ring.

In some embodiments, the end of each of the arms may be a hook.

In some embodiments, the grinding adapter may be connected onto ends of arms of a strainer support through fins extending from a shell of the grinding adapter.

Another broad aspect is an adapter for enabling grinding of one or more materials using a centrifugal mixer, the adapter to be fitted into a container for collecting the one or more materials once ground. The adapter includes a body defining an inner compartment, the body including openings; a filter positioned or for positioning around the body; and wherein the inner compartment is configured to receive grinding media for grinding the one or more materials and the openings are adapted to enable the one or more materials to enter and/or leave the inner compartment for grinding by the grinding media when subject to the centrifugal force applied by the centrifugal mixer while maintaining the grinding media in the inner compartment, and the filter is adapted to filter the one or more materials that are ground to a size suitable to pass through the filter.

In some embodiments, the adapter may include a platter, the body resting on the platter, the filter adapted to contact or contacting the platter, wherein the filter is adapted to rest or rests on an edge of the platter.

In some embodiments, the platter may include one or more spacers located around an edge of the platter.

In some embodiments, the platter may include a donut.

In some embodiments, one or more spacers that are a plurality of protrusions may extend outwardly from the body or the platter.

In some embodiments, the adapter may include a lid for sealing an upper opening of the filter.

In some embodiments, the adapter may include separator walls extending from a surface of the platter, positioned between the body of the adapter and an edge of the platter.

In some embodiments, the adapter may include a series of hooks interspersed on a top edge of the body.

In some embodiments, the adapter may include an inner lid with protrusions for fitting into spaces defined by the hooks of the body following a rotation of the inner lid with respect to the body or a rotation of the body with respect to the lid.

In some embodiments, the centrifugal mixer may be a dual asymmetric centrifugal mixer.

Another broad aspect is a kit including an adapter as described herein and the container for receiving the adapter.

In some embodiments, the kit may include a lid for sealing the container.

In some embodiments, the container may include steps located on an inner wall of the container, for receiving a base of the adapter and creating a space between the base of the adapter and a base of the container when the adapter is received on the steps.

In some embodiments, each step may include a through.

Another broad aspect is a method of grinding one or more materials using a centrifugal mixer. The method includes colliding the one or more materials with grinding media within an adapter positioned within the centrifugal mixer when subject to the centrifugal force applied by the centrifugal mixer; and filtering based on size the one or more materials that are ground through the colliding with the grinding media, wherein the one or more materials that have a sufficiently small size for being filtered are collected.

In some embodiments, the method may include redirecting the grinding media the one or more materials using separator walls of the adapter.

Another broad aspect is one or more materials that are ground by performing the method as described herein.

### BRIEF DESCRIPTION OF THE DRAWINGS

The invention will be better understood by way of the following detailed description of embodiments of the invention with reference to the appended drawings, in which:

FIG. 1A is a drawing of a front view of an exemplary grinding adapter including an exemplary lid and an exemplary body joinable to the lid;

FIG. 1B is a drawing of a top-perspective view of the lid and the body of the adapted for FIG. 1B;

FIG. 1C is a drawing of an exemplary portion of a shell of an exemplary adapter with exemplary grinding media contained therein;

FIG. 2 is a drawing of an exemplary lid of an exemplary grinding adapter and an exemplary strainer support for joining to a container of a dual asymmetric centrifugal mixer for removing excess materials from the exemplary adapter following grinding;

FIG. 3 is a flowchart diagram of an exemplary method of grinding one or more materials using a dual asymmetric centrifugal mixer;

FIG. 4A is a drawing of a side view of an exemplary body of an exemplary grinding adapter, where a base of the body is blown-up to show a chamfered edge;

FIG. 4B is a drawing of a top-perspective view of the exemplary body of the exemplary adapter of FIG. 4A;

FIG. 4C is a drawing of a top view of the exemplary body of the exemplary adapter of FIG. 4A;

FIG. 5A is a drawing of a top-perspective view of an exemplary lid of an exemplary grinding adapter;

FIG. 5B is a drawing of a bottom-perspective view of the exemplary lid of the exemplary adapter of FIG. 5A;

FIG. 6A is a drawing of a side view of an exemplary body of an exemplary grinding adapter;

FIG. 6B is a drawing of a bottom-perspective view of the exemplary body of the exemplary grinding adapter of FIG. 6A;

FIG. 7 is a drawing of an exemplary container containing an exemplary grinding adapter;

FIG. 8 is a drawing of an exemplary container fit with an exemplary strainer support for receiving a grinding adapter;

FIG. 9 is a drawing of an exemplary container with an exemplary strainer support mounted thereon, where an exemplary grinding adapter is mounted to the strainer support;

FIG. 10 is a drawing of an exemplary container with an exemplary adapter with an exemplary support integrated therein with elongated arms extending therefrom;

FIG. 11 is a drawing of an isometric view of an exploded exemplary adapter with an exemplary filter;

FIG. 12 is a drawing of an isometric view of the exploded adapter of FIG. 11, for fitting into an exemplary container;

FIG. 13 is a drawing of an isometric view of an exemplary adapter with an exemplary filter, where the body of the adapter is located within the filter;

FIG. 14 is a drawing of an isometric view of a portion of an exemplary adapter for receiving a filter of the adapter;

FIG. 15 is a drawing of an isometric view of an exemplary lid for joining to a top of a body of an adapter;

FIG. 16 is a drawing of an isometric view of an exemplary lid for a container;

FIG. 17 is a drawing of an isometric view of an assembled exemplary adapter with an exemplary filter, located within an exemplary container with an exemplary lid; and

FIG. 18 is a drawing of an isometric view of an exemplary container.

### DETAILED DESCRIPTION

The present disclosure relates to adapting a dual asymmetric centrifugal mixer, used for mixing materials, for the purpose of grinding down one or more materials found in the container of the dual asymmetric centrifugal mixer.

The adaptation of the dual asymmetric centrifugal mixer for grinding is achieved through the use of an adapter as described herein. The adapter is inserted into the container of the dual asymmetric centrifugal mixer.

The adapter includes a shell defining an inner compartment for receiving or that contains grinding media. Openings through the shell of the adapter permit flow of the one or more materials between the inner compartment of the adapter and the container of the dual asymmetric centrifugal mixer. When a centrifugal force is applied by the dual asymmetric centrifugal mixer to the container and to the adapter contained therein, the one or more materials can enter and/or exit the inner compartment. Once the one or more materials are located in the inner compartment of the adapter, the one or more materials can encounter the grinding media, resulting in comminution between the grinding media and the one or more materials, causing the grinding of the one or more materials.

As such, the dual asymmetric centrifugal mixer may be used for grinding when benefitting from the adapter.

### Definitions

In the present disclosure, by “container”, it is meant the vessel (e.g. jar) of the dual asymmetric centrifugal mixer that is designed to receive materials to be mixed by the dual asymmetric centrifugal mixer, when the adapter is not present. With the adapter, the container receives the adapter, and the container serves as a vessel for collecting or containing the one or more materials that have been or are being ground through use of the adapter. The container is subject to a centrifugal force exerted by the dual asymmetric centrifugal mixer.

In the present disclosure, by “dual asymmetric centrifugal mixer”, also known as a “planetary centrifugal mixer”, it is meant a machine that rotates an angled container eccentrically around a central axis, while the container spins on its own axis in the opposite direction. By “angled container”, it is meant that the two planes of rotation are not parallel, but instead form an angle. Exemplary dual asymmetric centrifugal mixers include, but are not limited to, the FlackTek SpeedMixer™, the THINKY™ mixer, the MAZ™ mixer, the Hauschild SpeedMixer™, etc. A “dual asymmetric centrifugal mixer”, as referred to herein, may also be known as a “planetary centrifugal mixer”.

In the present disclosure, by “grinding media”, it is meant objects added to the adapter to cause the grinding of the one or more materials through collisions between the units of grinding media, or grinding media and the shell of the adapter, where the one or more materials are trapped between the colliding units of grinding media and/or the units of grinding media and the shell of the adapter, where the collision energy causes, e.g., the granules to break up into smaller parts. The grinding media may be spherical, non-spherical (e.g. cylindrical, prismatic, etc.), etc.

In the present disclosure, by “one or more materials”, it is meant the one or more materials that are added to the container of the dual asymmetric centrifugal mixer or to the adapter that are to be ground. These may be any range or combination of materials including but not limited to ores, pharmaceuticals, plastics, pigments, agricultural products, etc. where it is necessary to reduce the average particle size of the sample. It may also include chemical reagents for the purpose of carrying out a mechanochemical reaction. Some materials may be solids, while other materials may be liquid. The one or more materials may be solid, liquid, or include both solid materials and liquid materials.

### Exemplary Grinding Adapter for a Dual Asymmetric Centrifugal Mixer:

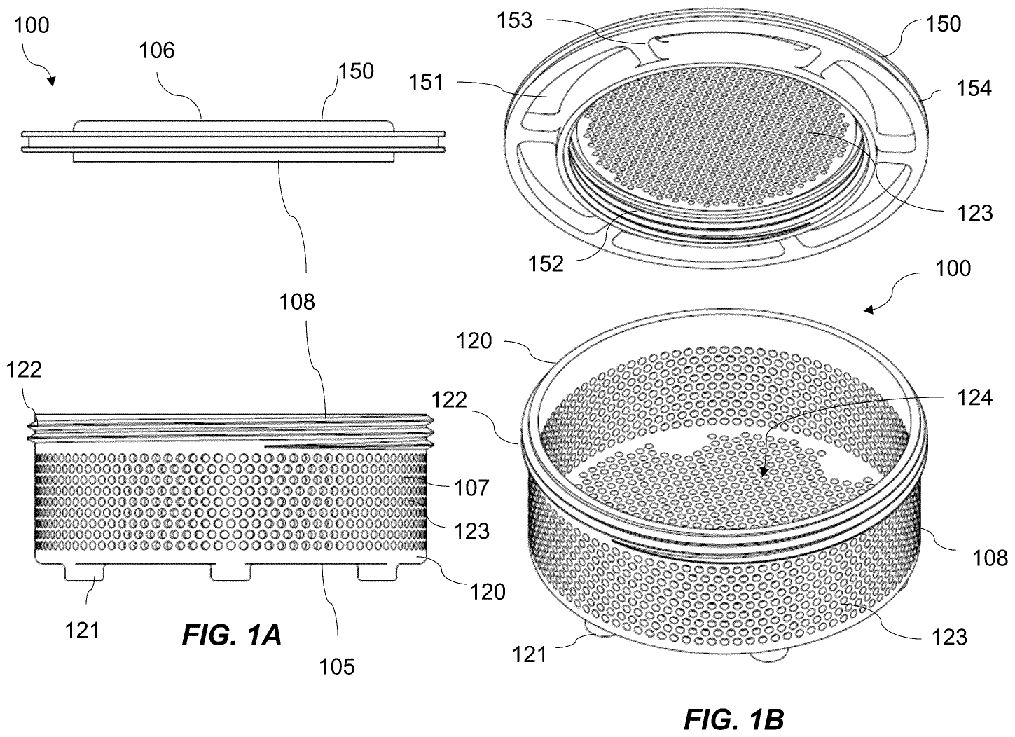

Reference is now made to FIGS. 1A and 1B, illustrating an exemplary grinding adapter 100 for a dual asymmetric centrifugal mixer, the adapter 100 fitting within a container of the dual asymmetric centrifugal mixer and enabling grinding of one or more materials found in the container (either present in the adapter 100 and/or in the container of the dual asymmetric centrifugal mixer).

The adapter 100 has a shell 108 and an inner compartment 124 for receiving grinding media. The inner compartment 124 is accessible through openings 123, found through the shell 108, for allowing the one or more materials to flow between the container of the dual asymmetric centrifugal mixer and the inner compartment 124, the one or more materials located within the inner compartment 124 colliding with the grinding media also contained in the inner compartment 124, resulting in comminution when the container and the adapter 100 contained therein are subject to a centrifugal force applied by the dual asymmetric centrifugal mixer.

For instance, FIG. 1C illustrates exemplary grinding media 169 contained in the inner compartment 124 of the adapter 100.

In some examples, the size of the openings 123 impedes passage of one or more materials of a certain size (filtering based on size). As such, in some embodiments, when the one or more materials are located within the inner compartment 124, they may only leave the inner compartment 124, to flow into the container of the dual asymmetric centrifugal mixer, once they have been ground down to a certain size. In other examples, the openings 123 may be sufficiently large compared to the starting size of the materials to be ground to allow for bidirectional passage (both pre and post grinding) of the one or more materials to and from the grinding adapter 100. The openings 123 are sufficiently small to prevent the grinding media from leaving the grinding adapter 100.

The adapter 100 may include a support 121 for creating a space between the base of the container of the dual asymmetric centrifugal mixer and the base 105 of the adapter 100 (e.g. feet 121 for resting on a base of the container of the dual asymmetric centrifugal mixer). The adapter 100 may include a lid 150 and a body 120. However, in some examples, the shell 108 of the adapter 100 may be a single integral unit, with the grinding media trapped in the inner compartment 124.

In some examples, the adapter 100 may not include a support 121, where the adapter 100 rests on the base of the container (e.g. container) used with the dual asymmetric centrifugal mixer.

The support 121 may be found when the adapter 100 is used for grinding one or more dry materials.

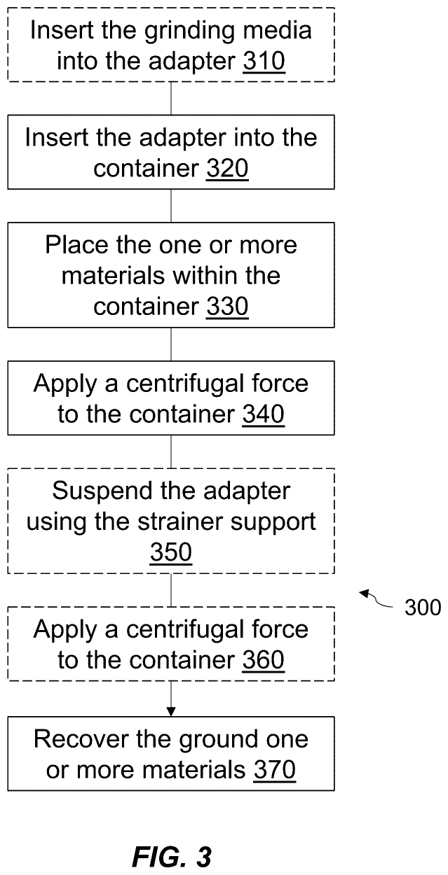

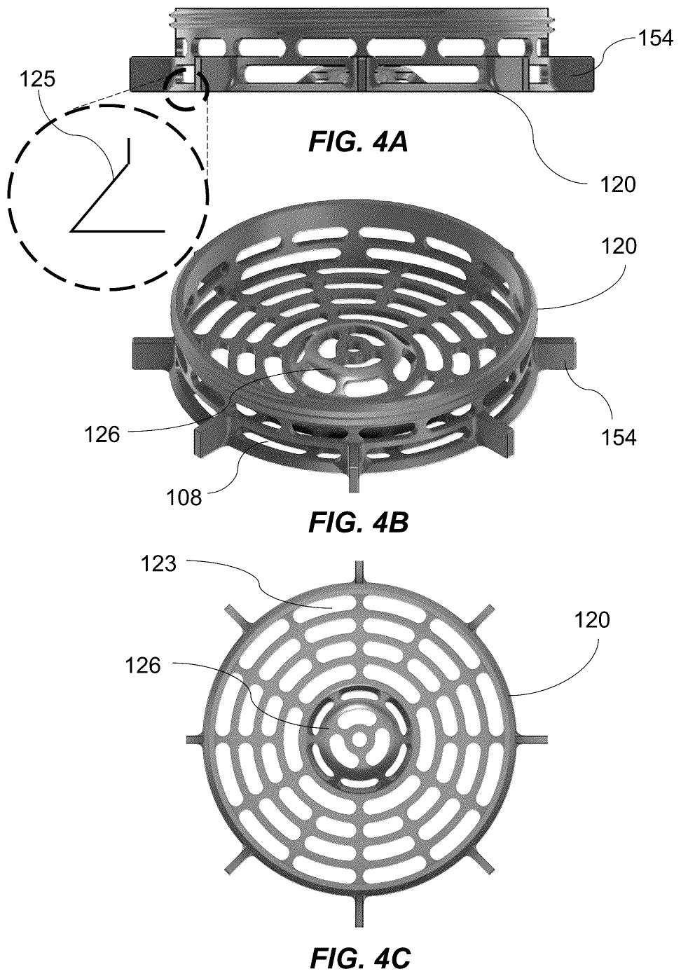

The openings 123 may form a grid, where the openings may be a matrix of perforations. The openings 123 may be located on the base 105 of the adapter 100, the wall 107 of the adapter 100 and/or the top 106 of the adapter 100. In some examples, the matrix of openings 123 may function as a sieve, for separating smaller from coarser particles of the one or more materials. In some examples, the openings 123 may be or may include a series of slits through the shell 108, as illustrated for instance in FIGS. 4A-4C, 5A-5B and 6A-6B. The openings 123 may allow the material to be ground, or ground material to flow in and out of the grinding adapter 100, while preventing the grinding media from leaving the grinding adapter 100.

The slits 123 may form a concentric pattern as illustrated in FIGS. 4A-4C.

The openings 123 may be of equal or unequal size.

In some examples, the openings 123 may result from the shell 108 being formed by a porous mesh, the shell 108 acting as a cage for containing the grinding media through a network of interconnecting filaments (e.g. metal filaments).

The openings 123 are dimensioned to be smaller than the size of the grinding media, such that the grinding media does not pass through the openings 123 when the adapter 100 is subject to centrifugal force by the dual asymmetric centrifugal mixer.

In some instances, as illustrated in the example of the shell 108 of the adapter 100 found in FIGS. 4A-4C, a base of the shell 108 may not be flat, where the base of the shell 108 may include a dome or nipple 126 to, e.g., accommodate a shape of a base of a container 170 in which the grinding adapter 100 is to be placed. For instance, the dome 126 may be shaped to accommodate for irregularities in the shape of the base of the container 170, e.g. such as irregularities resulting from the injection molding process producing the container 170.

In some embodiments, when the lid 150 is detachable from the body 120, the lid 150 may be fastened to the body 120 before grinding. In some implementations, the lid 150 may also be detached from the body 120 to gain access to the inner compartment 124, to, e.g., remove ground one or more materials contained therein, remove the grinding media, etc. Threads 152 of the lid 150 may complement the threads 122 of the body 150, such that the lid 150 may screw onto the body 120. In some examples, a tight fit between the lid 150 and the body 120 may also be used to fasten the lid 150 to the body 120. It will be understood that other mechanisms may be used to fasten the lid 150 to the body 120.

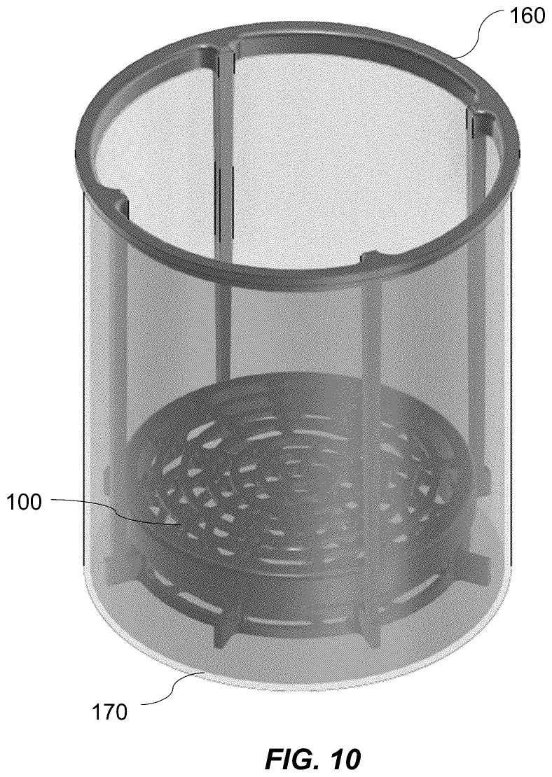

The support 121 may be or include feet 121 for resting the adapter 100 on the base of the container, and for creating a space between the base 105 of the adapter 100 and the base of the container, to allow ground one or more materials to flow more readily through the openings 123 located at the base 105 of the adapter 100, unimpeded by the base of the container of the dual asymmetric centrifugal mixer. The number of supports 121 may vary (e.g. 3, 4, 5, 6, etc.). The dimensions of the supports 121 may also vary. In some examples, the supports 121 may be shaped as portions of an arc, curving along and following an edge of the base 105 of the adapter 100. In other examples, the supports 121 may be protrusions or stumps extending outwardly from the base 105, as shown in FIGS. 1A and 1B. In some examples, the adapter 100 may include, as supports 121, extensions extending upwardly (e.g. instead of feet 121), away from the base 105, for joining (e.g. hooking) onto a rim of the container of the dual asymmetric centrifugal mixer, suspending the adapter 100 above the base of the container, thereby creating a space between the base 105 of the adapter 100 and the base of the container of the dual asymmetric centrifugal mixer (as illustrated, for instance, in the example shown in FIG. 10).

In some instances, the support 121 may be a ring located at the base 105, defined by the perimeter of the base 105.

In some embodiments, the adapter 100 may include a spacer 154 for contacting the wall of the container of the dual asymmetric centrifugal mixer, reducing or preventing movement of the adapter 100 in the container. This reduction of movement of the adapter 100 in the container of the dual asymmetric centrifugal mixer may be to reduce damage caused by collisions between the adapter 100 and the walls of the container of the dual asymmetric centrifugal mixer when subject to centrifugal force. The spacer 154 may be in the shape of a ring as shown in FIG. 1B, or as extensions projecting outwardly from the adapter 100. The spacer 154 may be joined to the shell 108 of the adapter 100 (e.g. present at the level of the lid 150 of the adapter 100, or at the level of the body 120 of the adapter-its location may depend on the shape of the adapter 100). For instance, as illustrated in FIGS. 4A-4C, the spacer 154 may be a group of extensions, in the shape of fins, projecting outwardly, from the shell 108. The fins 154 may be interspersed around the shell 108 of the adapter 100. The fins 154 may be of a sufficient length to press into the walls of the container 170 when the adapter 100 is lowered into the container 170. The contact between the fins 154 and the walls of the container 170 achieve a tight-fit, anchoring the adapter 100 into the container 170 during the centrifugal process carried out by the dual asymmetrical centrifugal mixer. The fins 154 may deform the walls of the container 170 to further anchor the adapter 100 to the container 170. Moreover, during the grinding process, when a centrifugal force is applied to the adapter 100 placed in the container 170, the materials exiting the adapter 100 may be collected on a surface of a fin 154, the fin 154 acting as a paddle, the materials then leaving the fin 154 and returning into the adapter 100 for further grinding as the adapter 100 and container 170 rotate.

In some instances, a base of the shell 108 may include an angled or chamfered edge 125. The chamfered edge 125 may be defined on a step extending outwardly from the shell 108. The chamfered edge 125 creates a ramp for the one or more materials, during the grinding process, to enable the one or more materials to re-enter the inner compartment 124 during the grinding process, instead of accumulating at the external base of the shell 108. In some examples, the chamfered edge 125 may be angled at 45 degrees. However, it will be understood that the chamfered edge 125 may be set at a different angle without departing from the present teachings. In some instances, the spacer or fins 154 may be located on the container 170 instead of on the grinding adapter 100 (not shown). The fin 154 may be located next to a base of the container 170, extending inwardly from the inner wall of the container 170 into the inner space of the container 170. In some instances, the grinding adapter 100 may be adapted to fit between the spacer or fins 154 extending inwardly from the inner wall of the container 170.

In some embodiments, the spacer 154 may include elastomeric material for softening contact between the adapter 100 and the container of the dual asymmetric centrifugal mixer. For instance, when the spacer 154 is shaped as a ring, the elastomer may be shaped as a loop defined around an outer edge of the spacer ring 154.

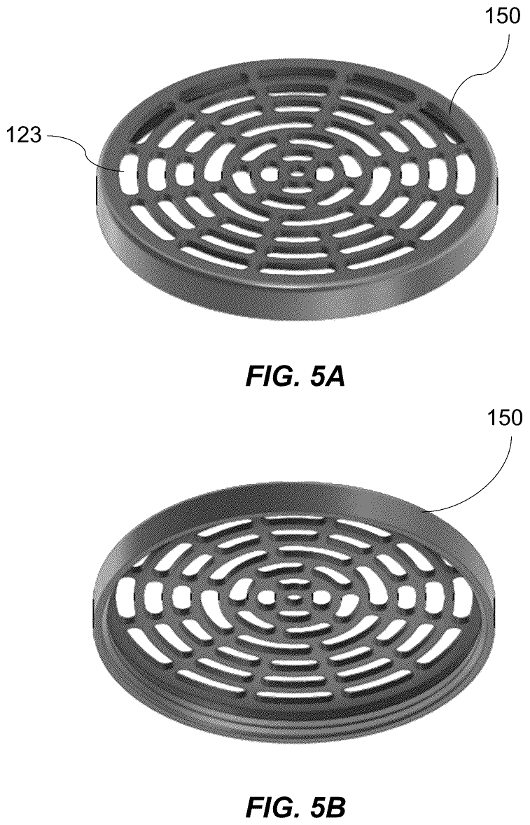

In some embodiments, the spacer 154 may include a plurality of nipples extending outwardly, as shown in FIGS. 6A-6B.

In some examples, the feet 121 may act as spacers, extending outwardly from the base of the shell 108.

In some instances, the adapter 100 may have a spherical shape (e.g. where, in some instances, the halves of the sphere of the adapter 100 may be detachable to access the inner compartment 124), a cylindrical shape as shown in FIG. 1B, have a dome shape, etc. The shape of the adapter 100 may vary (e.g. the shell 108 may be a doughnut as shown in FIGS. 6A-6B). However, it will be understood that a grinding adapter with corners may be less preferable as the corners may be damaged or damage the container of the dual asymmetric centrifugal mixer when the adapter collides with the container of the dual asymmetric centrifugal mixer. In some examples, the shell 108 of the adapter 100 may include a base 105, a top 106 opposite the base 105, and a wall 107 interconnecting the base 105 to the top 106 (as shown in FIGS. 1A and 1B). The wall 107 may have a cylindrical shape, and each of the base 105 and the top 106 may be shaped as discs.

### Exemplary Strainer Support for a Grinding Adapter:

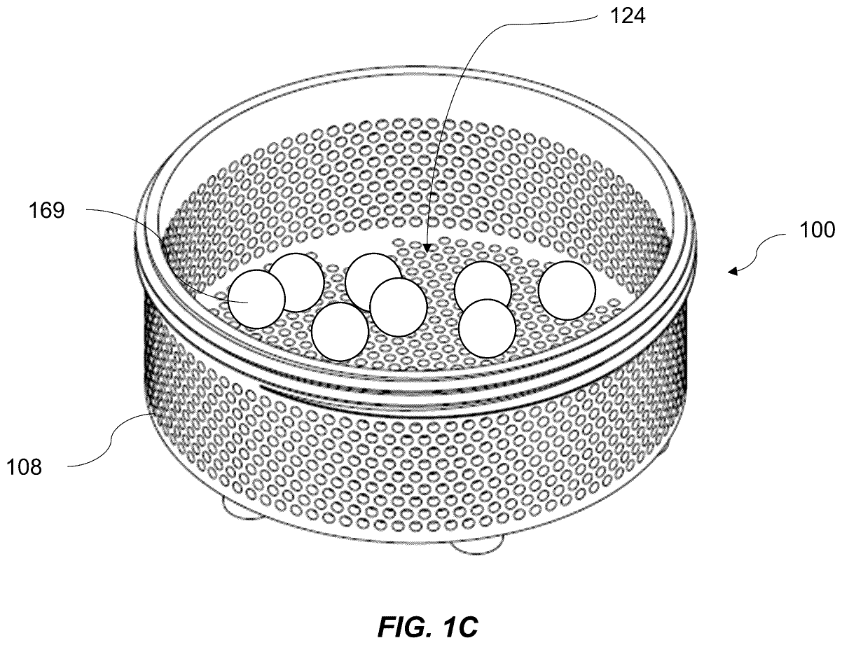

Reference is now made to FIG. 2, illustrating an exemplary strainer support 160 for resting on a top of the container of the dual asymmetric centrifugal mixer and joining to the adapter 100 (e.g. to the lid 150 of the adapter 100), suspending the adapter 100 over the base of the container of the dual asymmetric centrifugal mixer. A centrifugal force can then be applied by the dual asymmetric centrifugal mixer to the suspended adapter 100, the centrifugal force causing residual one or more materials to leave the adapter 100, collecting in the container of the dual asymmetric centrifugal mixer. For instance, when the one or more materials contain a viscous liquid, the centrifugal force accelerates the rate at which the residues leave the adapter 100, thereby facilitating cleaning of the adapter 100 and reducing waste of the one or more materials.

The strainer support 160 includes a main body 162 and arms 161 extending from the main body 162.

The main body 162 of the strainer support 160 rests on a top (e.g. a rim) of the container of the dual asymmetric centrifugal mixer.

In one example, the main body 162 may be shaped as a ring with a diameter that is greater than the diameter of the base of the container of the dual asymmetric centrifugal mixer, for fitting over the rim of the container of the dual asymmetric centrifugal mixer, resting thereon.

The arms 161 are configured to join to the adapter 100, thereby anchoring the adapter 100 to the main body 162 of the strainer support 160. The length of the arms 161 are such that, once the adapter 100 is joined to the strainer support 160 and the main body 162 of the strainer support 160 is resting on the rim of the container, the adapter 100 is suspended above the base of the container of the dual asymmetric centrifugal mixer, resulting in a space between the side of the adapter 100 closest to the base of the dual asymmetric centrifugal mixer, and the base of the dual asymmetric centrifugal mixer, the space allowing the one or more materials to clear the adapter 100 for purposes of straining (e.g. while taking into consideration a volume of one or more materials that may already be found in the container).

The arms 161 are oriented to extend into the container of the dual asymmetric centrifugal mixer when the main body of the strainer support 160 rests on the rim of the container of the dual asymmetric centrifugal mixer.

The arms 161 may include hooks 161a at the ends of the arms 161.

In the example of the lid 150 shown in FIG. 2, the lid 150 includes protrusions 153 (e.g. spokes that extend radially from the center of the lid 150), the protrusions 153 defining openings 151. The hooks 161a may fit into the openings 151 of the lid 150, and hook onto the protrusions 153 of the lid 150. The hooks 161a may lock onto the protrusions 153 following a rotation of the adapter 100 with respect to the strainer support 160, or the strainer support 160 with respect to the lid 150. The protrusions 153 of the adapter 100 may fit into the cavities 161b of the arms 161, the cavities 161b resulting from the shape of the arm 161 (e.g. the gap and the bend of the end of the arms 161 resulting in the hook 161a).

The protrusions 153 may be present between the spacer 154 and the shell 108 of the adapter 100. It will be understood that even though FIGS. 1B and 2 show the spacer 154, the protrusions 153 and the openings 151 located at the level of the lid 150, the spacer 154, the protrusions 153 and the openings 151 may be situated with respect to another part of the adapter 100 (e.g. connected to and defined by the body 120 of the adapter 100).

Even though the example of FIG. 2 shows the strainer support 160 relating to a lid 150 of the adapter 100, it will be understood that the strainer support 160 may join to another part of the adapter 100 (e.g. the body 120 of the adapter 100) or to an adapter 100 that does not have a lid 150 (e.g. an adapter 100 that forms a single, unified whole).

Once the adapter 100 is joined to the strainer support 160, the centrifugal force may be applied to the adapter 100 by the dual asymmetric centrifugal mixer. The strainer support 160 holds the adapter 100 above the base of the container of the dual asymmetric centrifugal mixer, despite the application of the centrifugal force, due to the contact made between the main body 162 of the strainer support 160 and the rim of the container of the dual asymmetric centrifugal mixer.

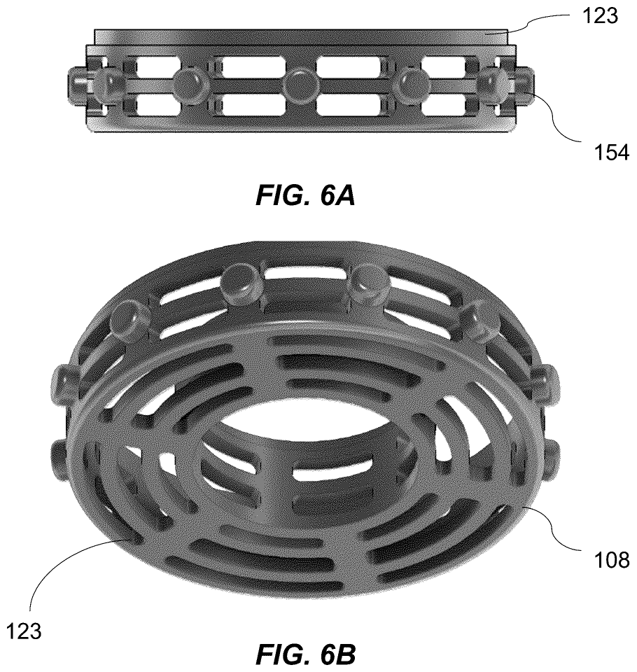

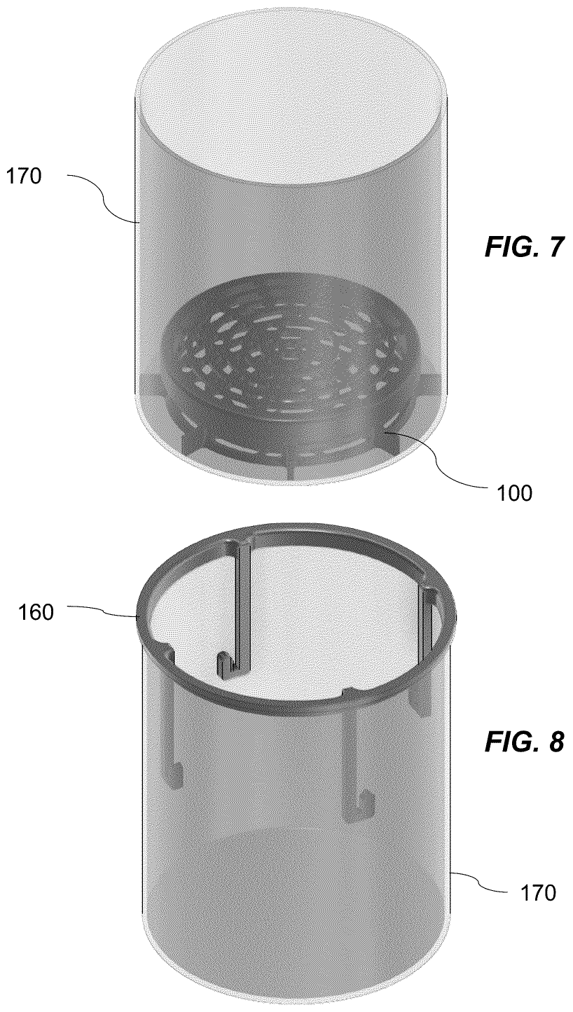

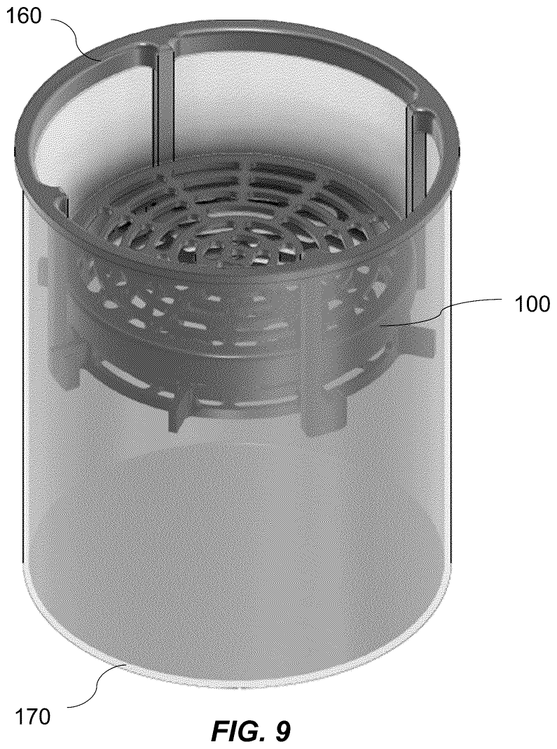

FIG. 8 illustrates an exemplary strainer support 160 mounted onto rim of a container 170 used with a dual asymmetric centrifugal mixer. FIG. 7 illustrates an exemplary grinding adapter 100 placed at the bottom of the container 170, where the spacer 154 is a series of fins. As illustrated in FIG. 9, for purposes of straining materials coating the adapter 100, the arms 161 of the strainer support 160 suspend the adapter 100 by the fins 154. The cavities 161b of the hooks 161a receive the fins 154, supporting the adapter 100 and preventing or limiting the adapter 100 from moving when subject to a centrifugal force. The centrifugal force causes the ground one or more materials coating the adapter 100 to be pulled from the adapter 100, returning into the container 170 to minimize waste and increase yield.

Exemplary Adapter with a Filter:

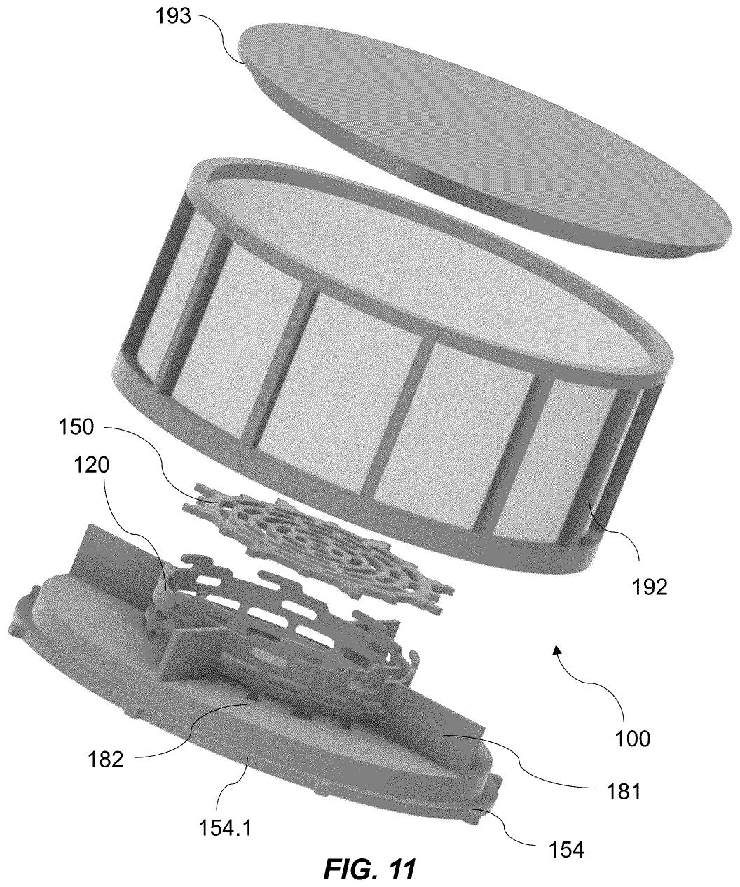

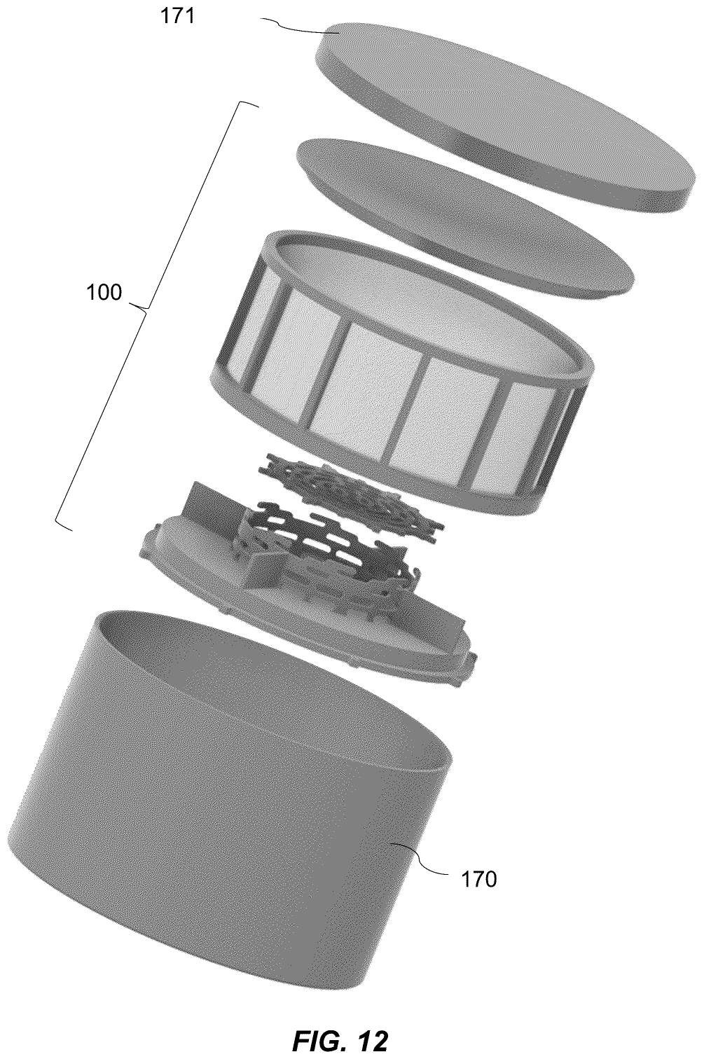

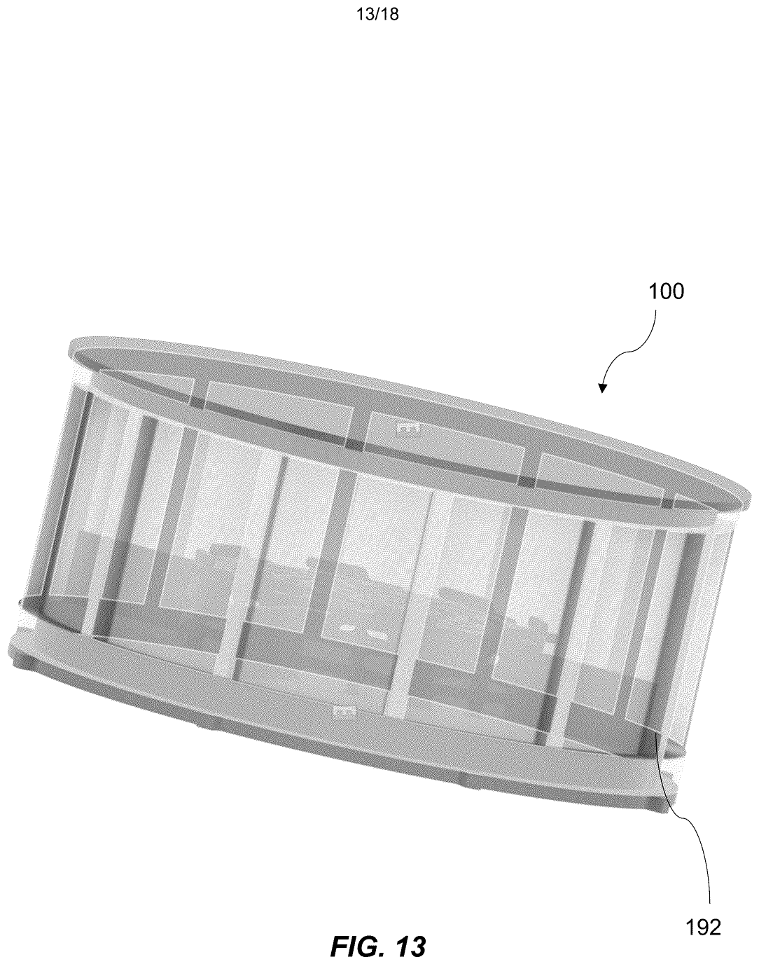

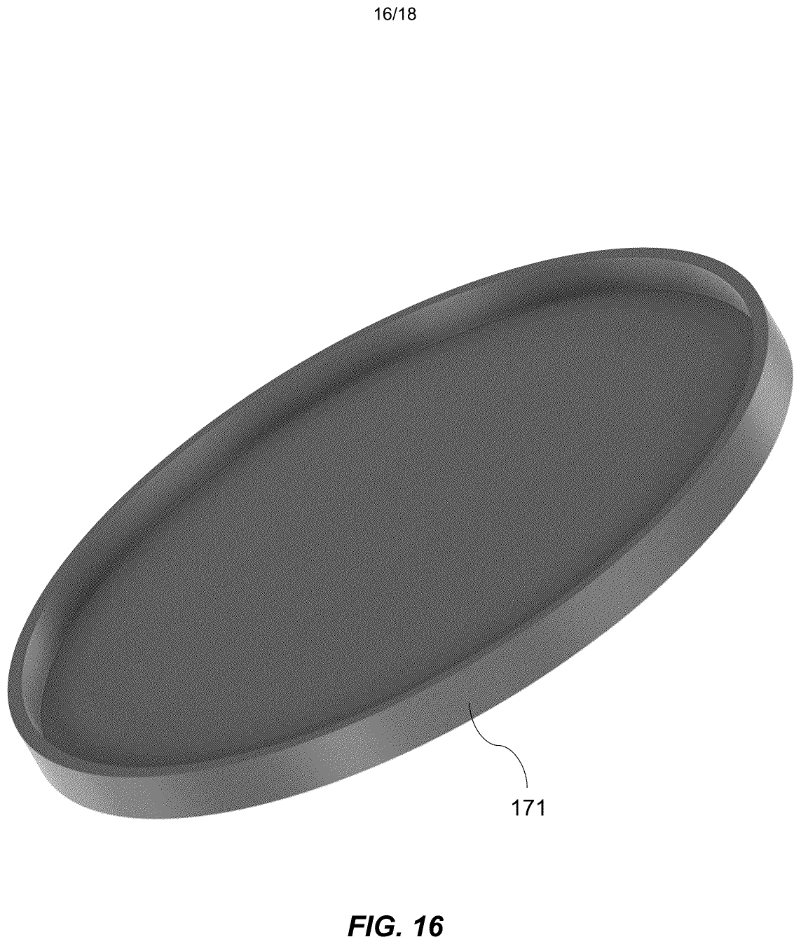

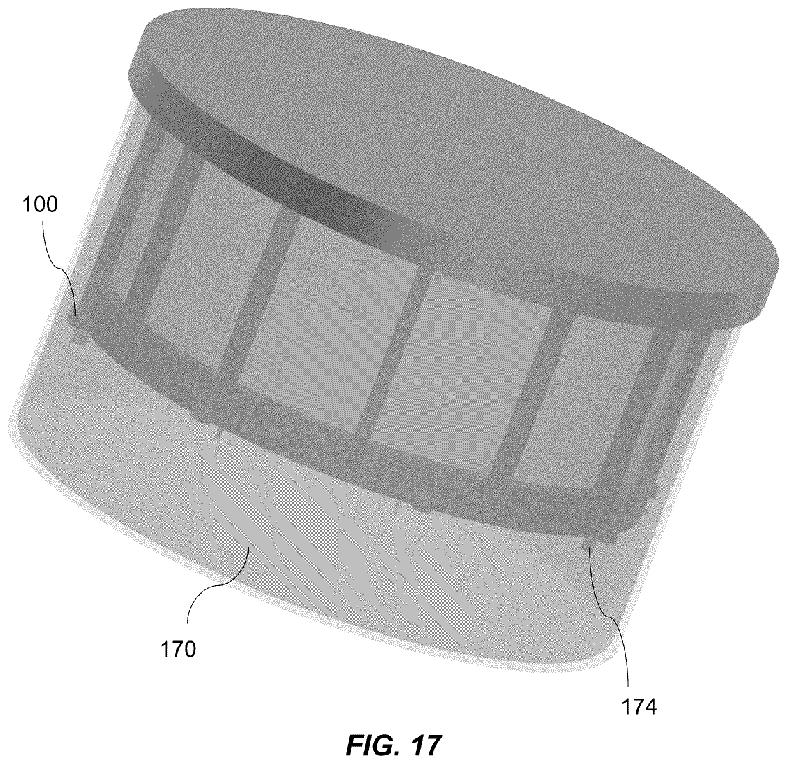

Reference is now made to FIGS. 11-17, illustrating an exemplary adapter 100 with a filter 192, for use with a centrifugal mixer. The filter 192 may be integrated to the rest of the adapter 100, or detachable from the rest of the adapter 100.

The adapter 100 with filter 192 is to be placed in a container 170 (optionally sealed with a lid 171) that is added to the centrifugal mixer. Particles that are ground to a sufficiently small size leave the adapter 100 by passing through the filter 192 and are collected in the body of the container 170. This selection based on size permits the selection of maximum final particle size, a narrower distribution of particle sizes, and frees up the space in the body 120 of the adapter 100 for materials that have not yet achieved the requisite size for passing through the filter 192.

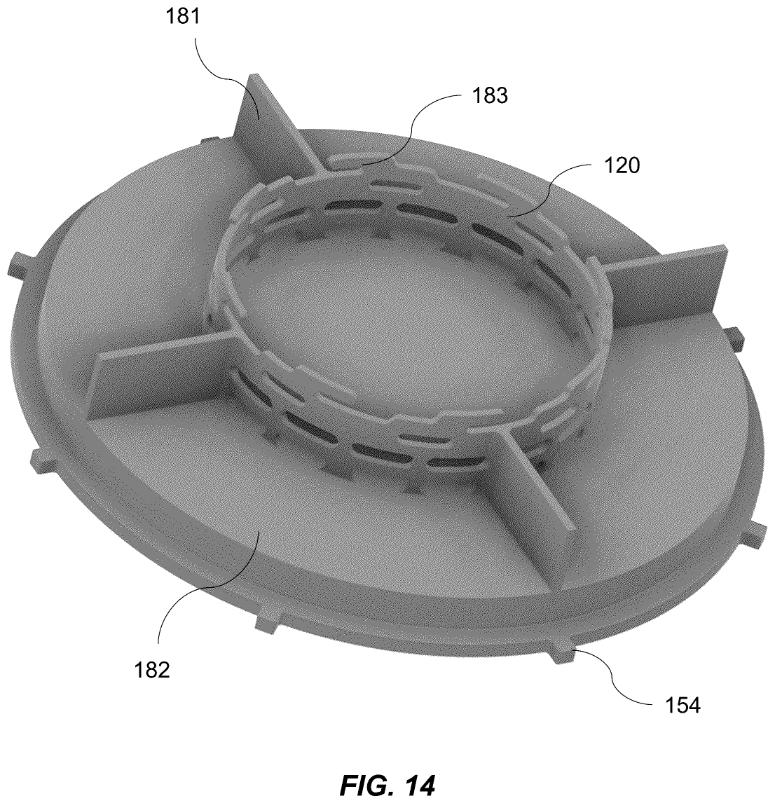

The adapter 100 may include a platter 182 that is connected to and extends away from the body 120. The platter 182 may have a width that is greater than the width of the body 120, as shown in FIG. 14. The body 120 may rest on the platter 182. Separator walls 181 may extend radially from the body 120. The separator walls 181 are joined to the platter 182, extending vertically from the surface of the platter 182. The separator walls 181 may be orthogonal with a plane defining the surface of the platter 182. The separator walls 181 separate the surface area of the platter 182 into segments, causing material that leaves the body 120 to be redirected into the body 120 following the application of a centrifugal force. The separator walls 181 may be defined between the body 120 and the edge of the platter 182, as shown in FIG. 14. The separator walls 181 may be aligned radially with a center of the adapter 100 (body of the adapter 120).

The spacers 154 may be placed around a base of the platter 182. The spacer(s) 154 may be a plurality of abutments 154 interspersed around the platter 182, or extending from a donut 154.1 that surrounds the platter 182 and that may have a height that is less than the height of the platter 182 to receive the filter 192 (as shown in FIG. 11).

The filter 192 may be configured to contact and, optionally, to rest upon the adapter 100. The filter 192 may sit on top of the donut 154.1. The filter 192 may sit on top of the platter 182. The filter 192 may be exchangeable and detachable from a rest of the adapter 100, where multiple filters 192 may be provided, each of the filters 192 having a different mesh size for selecting a different particle size. In some instances, the filter 192 may rest along an edge of the platter 182.

In some instances, the filter 192 may rest on and contact the donut 154.1.

In some instances, the filter 192 may have a diameter that is greater than the width of the platter 182. The filter 192, when placed over the rest of the adapter 100, may create a tight fit with the platter 182, the contact between the platter 182 and the filter 192 preventing one or more materials from passing through the contact point defined between the platter 182 and the filter 192.

In some instances, a lid 193 may be provided for placing on top of, and for sealing, a top opening of the filter 192, and for preventing one or more materials from escaping into the collection container 170 through the opening instead of through the filter 192.

The lid 193, the filter 192 and the platter 182 may form a cylinder containing the rest of the adapter 100 (e.g. the body 120 and the lid 150), for positioning in the container 170.

Therefore, the radius of each of the platter 182, the lid 193 and the filter 192 may be less than the radius of the container 170, for permitting the adapter 100 to fit into the container 170.

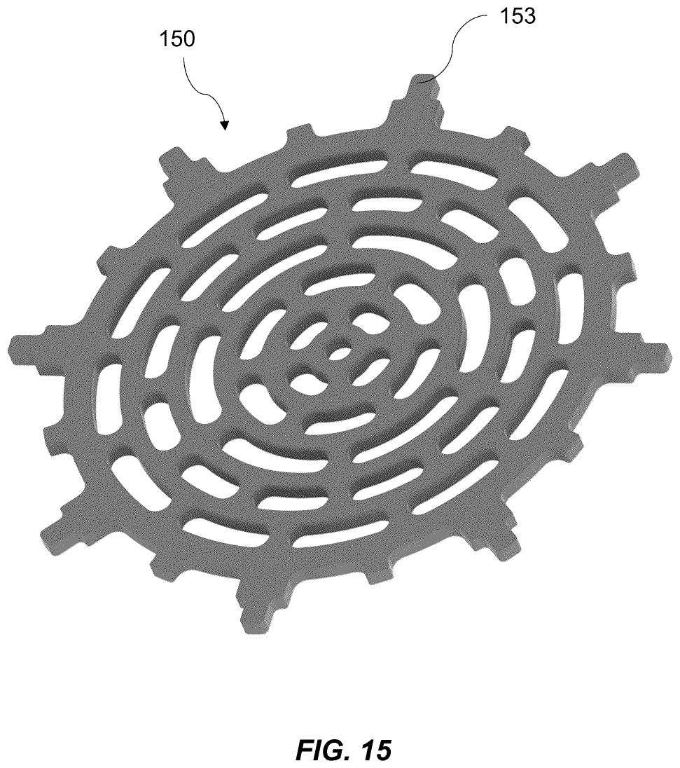

In some instances, as shown in FIG. 15, a top of the body 120 may include teeth or hooks 183, the hooks 183 defining spaces for receiving the protrusions 153 extending from the edge of the lid 150. The protrusions 153 fit into the spaces of the hooks 183, thereby locking the lid 150 onto the body 120, following a rotation of the body 120 with respect to the lid 150, or the lid 150 with respect to the body 120.

The adapter 100 may be used with a centrifugal mixer, such as a dual asymmetric centrifugal mixer, a planetary mill, etc.

When a centrifugal force is applied, the one or more materials, contained with the grinding media in the body of the adapter, is ground by the grinding media. The one or more materials can exit the body through the openings of the body. Once having exited the body, the one or more materials that are sufficiently ground and that have a size smaller than the openings of the filter can leave the adapter through the filter and are collected in the container that nests the adaptor.

Separator walls may be used to control the flow of the one or more materials when the centrifugal force is applied. The separator walls collect the one or more materials leaving the body of the adapter, and can guide the one or more materials back into the body of the adapter as the container changes its orientation while rotating in the centrifugal mixer.

In some instances, an inner wall of the container 170 may include steps 174 extending inwardly for supporting the adapter 100 placed in the container 170. The steps 174 are positioned at a distance from the base of the container 170, thereby creating a space between the base of the adapter 100 and the base of the container 170 when the adapter 100 is supported by the steps 174. When the ground material passes through the filter 192, the ground material is collected in the space defined between the base of the container 170 and the base of the adapter 100 sitting on the steps 174.

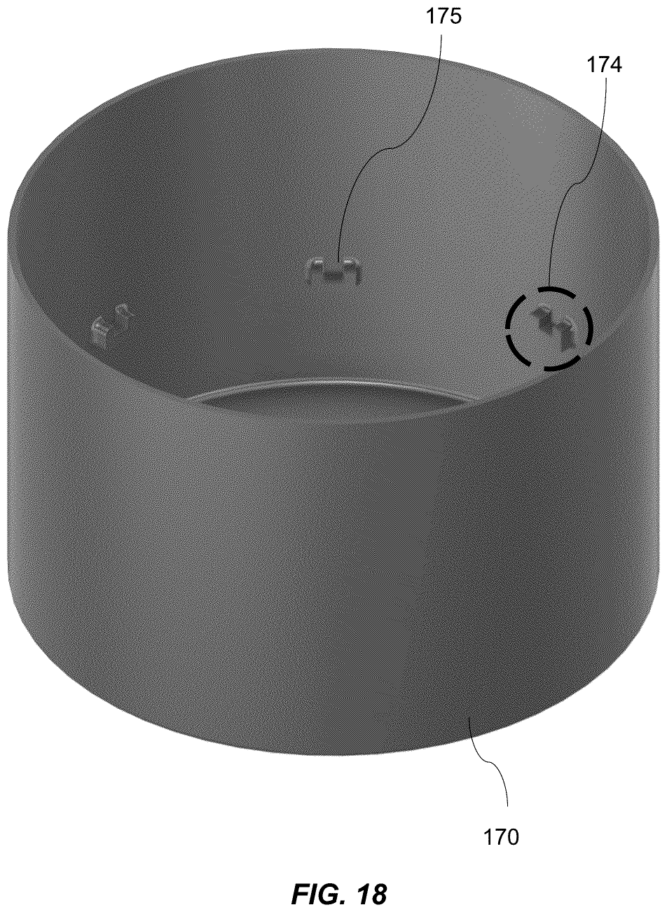

As shown in FIG. 18, the steps 174 may be structured to include a trough 175 defined in the step 174, where the shape of the trough 175 is adapted to receive the spacer 154 extending from the adapter 100. Therefore, when the spacers 154 are secured within the troughs 175, the adapter 100 does not rotate freely with respect to the container 170.

### Exemplary Method of Grinding One or More Materials Using a Dual Asymmetric Centrifugal Mixer:

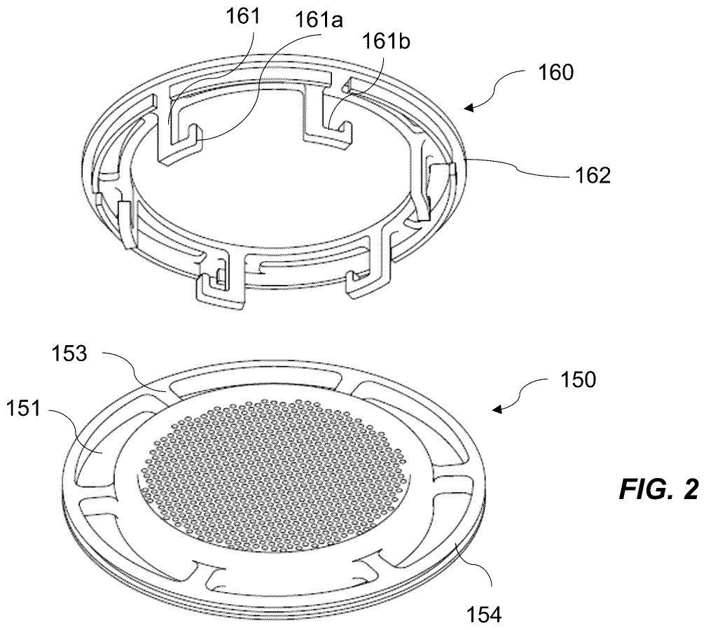

Reference is now made to FIG. 3, illustrating an exemplary method 300 of grinding one of more materials using a dual asymmetric centrifugal mixer. For purposes of illustration, reference is made to adapter 100 and to strainer support 160. However, it will be understood that any other adapter and/or strainer support in accordance with the present teachings may be used.

In some embodiments, when the inner compartment 124 of the adapter 100 may be accessible by detaching two parts of the shell 108 of the adapter 100 (e.g. detaching a lid 150 from a body 120), the grinding media may be added to the adapter 100 at step 310, inserted into the inner compartment 124 of the adapter 100. However, in other embodiments, the grinding media may already be located in the inner compartment 124 of the adapter 100. In some instances, when the shell 108 permanently seals the inner compartment 124, the grinding media may be permanently located in the inner compartment 124 of the adapter 100.

The adapter 100 is inserted into the container of the dual asymmetric centrifugal mixer at step 320. In some examples, the adapter 100 may be dimensioned to achieve a snug-fit in the container of the dual asymmetric centrifugal mixer, reducing movement of the adapter 100 in the dual asymmetric centrifugal mixer for avoiding or limiting damage to the container by the adapter 100 and vice-versa (e.g. through the use of the spacer 154).

The insertion of the adapter 100 into the container of the dual asymmetric centrifugal mixer adapts the dual asymmetric centrifugal mixer, initially designed for mixing, for grinding the one or more materials through collisions with the grinding media retained in the inner compartment 124 of the adapter 100.

The one or more materials to be ground are placed within the container at step 330. In some examples, the one or more materials are placed in the container, outside of the adapter 100. In other embodiments, the one or more materials to be ground may be introduced into the container by placing the one or more materials in the inner compartment 124 of the adapter 100, e.g. with the grinding media. The large size of the unground one or more materials may prevent the unground one or more materials from leaving the inner compartment 124 through the openings 123, discriminated based on size as a result of the size of the openings 123.

In some instances, the one or more materials to be ground may be introduced into the container by placing the one or more materials into the container itself. The one or more materials may pass in and out of the grinding adapter, through the openings of the adapter, during grinding. The size of the openings of the adapter may be sufficient to accommodate the dimensions of the material to be ground.

A centrifugal force is then applied by the dual asymmetric centrifugal mixer to the container at step 340. The centrifugal force is applied to the adapter 100, located in the container, and to the grinding media and to the one or more materials, where comminution between the grinding media and the one or more materials occurs. As the one or more materials undergo comminution, their size reduces. In some examples, when the size of the one or more materials is sufficiently reduced, the ground one or more materials may filter through the openings 123, leaving the adapter 100. This clears the inner compartment 124 from one or more materials that are sufficiently ground, increasing contact between the larger one or more materials and the grinding media. In other examples, the one or more materials may flow freely and bidirectionally, to and from the grinding adapter, during grinding through the openings of the grinding adapter. The size of the openings of the adapter is sufficiently small to retain the grinding media in the grinding adapter.

Once the one or materials have been sufficiently ground, the centrifugal force may be stopped.

In some embodiments, following comminution, the adapter 100 may be suspended from a height of the container of the dual asymmetric centrifugal mixer at step 350. A strainer support 160 may be used.

The strainer support 160 may contact and be held by the rim of the container of the dual asymmetric centrifugal mixer, the base 162 of the strainer support 160 resting on the rim of the container of the dual asymmetric centrifugal mixer.

The adapter 100 may be joined to arms 161 of the strainer support 160, where the length of the protrusions 160 are adapted to hold the adapter 100 at a distance from the base of the container of the dual asymmetric centrifugal mixer, creating a space between the end of the adapter closest to the base of the container, and the base of the container of the dual asymmetric centrifugal mixer.

In some embodiments, the strainer support 160 may be integral with the adapter 100. In some examples, the adapter 100 may include protrusions extending vertically from the shell 108 of the adapter 100 for resting on the rim of the container (e.g. where the protrusions may rotate such that a hook or angled portion at an end of the protrusions may face outwardly for resting on the rim of the container or rotate inwardly when the adapter 100 is to rest of the base of the container of the dual asymmetric centrifugal mixer).

The adapter 100 may be connected to the strainer support 160 through a rotation of the adapter 100 or of the strainer support with respect to the other. The rotation may cause hooks 161a of the arms 161 of strainer support 160 to join to protrusions 153 of the adapter 100.

In some examples, the grinding adapter 100 may be transferred from a position of grinding in the bottom of container 107, as shown in FIG. 7, to a position of material recovery/cleaning, suspended above the base of the container by the strainer support 160, as shown in FIG. 9, through use of an implement such as tweezers, a hook, or any other device capable of clamping or maneuvering the adapter 100 to be mounted onto the strainer support 160.

With the adapter 100 suspended above the base of the container of the dual asymmetric centrifugal mixer, a centrifugal force may then be applied to the container of the dual asymmetric centrifugal mixer at step 360. The application of the centrifugal force results in the removal of residual one or more materials trapped on or coating the adapter 100. The one or more materials travel from the adapter 100 to the base of the container of the dual asymmetric centrifugal mixer, collecting in the container, away from the adapter 100, as the adapter 100 is suspended above the base of the container of the dual asymmetric centrifugal mixer. The removal of the one or more materials may facilitate cleaning of the adapter 100, and avoid waste of one or more materials that would instead be disposed of during cleaning of the adapter 100.

The adapter 100 is then removed from the container of the dual asymmetric centrifugal mixer, and the ground one or more materials are then recovered from the container of the dual asymmetric centrifugal mixer at step 370.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

What is claimed is:

1. An adapter for enabling grinding of one or more materials using a centrifugal mixer, the adapter to be fitted into a container for collecting the one or more materials once ground, comprising:
a body defining an inner compartment, the body including openings;
a filter positioned or for positioning around the body; and
wherein the inner compartment is configured to receive grinding media for grinding the one or more materials and the openings are adapted to enable the one or more materials to enter and/or leave the inner compartment for grinding by the grinding media when subject to the centrifugal force applied by the centrifugal mixer while maintaining the grinding media in the inner compartment, and the filter is adapted to filter the one or more materials that are ground to a size suitable to pass through the filter.

2. The adapter according to claim 1, further comprising a platter, the body resting on the platter, the filter adapted to contact or contacting the platter, wherein the filter is adapted to rest or rests on an edge of the platter.

3. The adapter according to claim 1, wherein the platter includes one or more spacers located around an edge of the platter.

4. The adapter according to claim 2, wherein the platter includes a donut.

5. The adapter according to claim 2, wherein one or more spacers that are a plurality of protrusions extend outwardly from the body or the platter.

6. The adapter according to claim 1, further comprising a lid for sealing an upper opening of the filter.

7. The adapter according to claim 1, further comprising separator walls extending from a surface of the platter, positioned between the body of the adapter and an edge of the platter.

8. The adapter according to claim 1, further comprising a series of hooks interspersed on a top edge of the body.

9. The adapter according to claim 8, further comprising an inner lid with protrusions for fitting into spaces defined by the hooks of the body following a rotation of the inner lid with respect to the body or a rotation of the body with respect to the lid.

10. The adapter according to claim 1, wherein the centrifugal mixer is a dual asymmetric centrifugal mixer.

11. A kit comprising:
the adapter according to claim 1; and
the container for receiving the adapter.

12. The kit according to claim 11, further comprising a lid for sealing the container.

13. The kit according to claim 11, wherein the container further comprises steps located on an inner wall of the container, for receiving a base of the adapter and creating a space between the base of the adapter and a base of the container when the adapter is received on the steps.

14. The kit according to claim 13, wherein each step comprises a through.

15. A method of grinding one or more materials using a centrifugal mixer, comprising:
colliding the one or more materials with grinding media within an adapter positioned within the centrifugal mixer when subject to the centrifugal force applied by the centrifugal mixer; and
filtering based on size the one or more materials that are ground through the colliding with the grinding media, wherein the one or more materials that have a sufficiently small size for being filtered are collected.

16. The method according to claim 15, further comprising redirecting the grinding media the one or more materials using separator walls of the adapter.

17. One or more materials that are ground by performing the method according to claim 15.
